(19) United States
(12) Patent Application Publication
(10) Pub. No.: US 2008/0260029 A1
(43) Pub. Date: Oct. 23, 2008

(54) STATISTICAL METHODS FOR PREDICTION WEIGHTS ESTIMATION IN VIDEO CODING

(76) Inventor: Bo Zhang, Westford, MA (US)

Correspondence Address: MCANDREWS HELD & MALLOY, LTD, 500 WEST MADISON STREET, SUITE 3400, CHICAGO, IL, 60661, US

(21) Appl. No.: 11/736,397

(22) Filed: Apr. 17, 2007

(51) Int. Cl. H04N 11/04

(52) U.S. Cl. 375/240.13; 375/E07.243

(57) ABSTRACT

Presented herein are system(s) and method(s) for statistically prediction of weighting parameter estimation in video encoding. In one embodiment, there is presented a method for interpredicting a picture from at least one reference picture. The method comprises calculating statistics for pixels in the picture and the reference picture; generating weight parameters for the picture based on the statistics; and encoding the picture using said weight parameters.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

A video sequence includes a series of images represented by frames. The frames comprise two-dimensional grids of pixels. An exemplary video sequence, such as a video sequence in accordance with the HDTV standard, is 1920×1080 pixel frames at 60 fields (equivalent to 30 frames) per second.

The foregoing results in a raw bit rate of approximately 1 Gbps for the video sequence. It requires tremendous amount of storage space to store such a video stream in raw format, which makes it impractical.

Accordingly, a number of video compression standards have been promulgated to alleviate the video storage or bandwidth requirements. One such standard known as H.264 (also known as MPEG 4 Part 10 Advanced Video Coding (AVC)) was developed by the Joint Video Team (JVT) project of the International Organization for Standardization (ISO) and the International Telecommunication Union (ITU).

Most video compression standards use a number of techniques to compress video streams. One of such techniques uses motion-based compensation to reduce temporal redundancy. It allows the prediction of a picture from one or more reference pictures.

The AVC standard furthermore allows the reference pictures to be linearly weighted before they are used for inter-predictions. The weighting of the reference pictures greatly helps the prediction quality in the case of fading scenarios due to movie editing or lighting condition changes.

Further limitations and disadvantages of conventional and traditional approaches will become apparent to one of skill in the art, through comparison of such systems with embodiments of the present invention as set forth in the remainder of the present application.

### BRIEF SUMMARY OF THE INVENTION

The present invention is directed to systems and methods for prediction weight estimation as shown in and/or described in connection with at least one of the figures, as set forth more completely in the claims.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 is block diagram describing interprediction coding in accordance with an embodiment of the present invention;

FIG. 2 is a block diagram of an exemplary circuit in accordance with an embodiment of the present invention;

FIG. 3 is a block diagram of an exemplary embodiment of the present invention in the context of the H.264 Video Encoding Standard;

FIG. 4 is a block diagram describing an exemplary video encoder in accordance with an embodiment of the present invention;

FIG. 5 is a flow diagram describing interprediction encoding in accordance with an embodiment of the present invention; and

FIG. 6 is a block diagram of an exemplary computer system configured in accordance with an embodiment of the present invention.

### DETAILED DESCRIPTION OF THE INVENTION

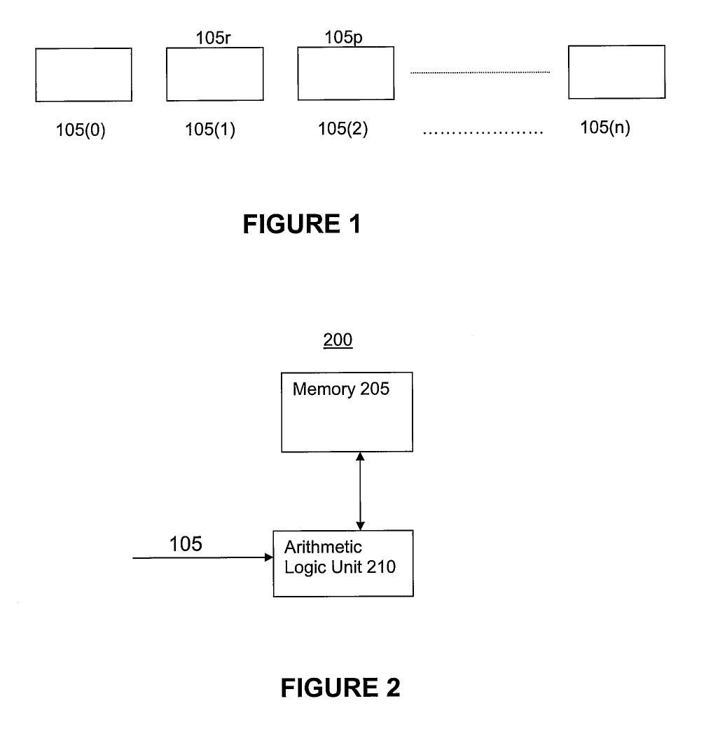

Referring now to FIG. 1, there is illustrated a block diagram describing interprediction of a video sequence 100 in accordance with an embodiment of the present invention. An exemplary video sequence 100 includes a sequence of pictures 105(0) . . . 105(n). The pictures include 2D pixel grids.

A video sequence 100 according to HDTV includes 30 pictures with 1920×1080 pixel grids per second. To reduce the amount of data and bandwidth needed to store and transmit the video sequence 100, some pictures, e.g., picture 105p, can be interpredicted from reference pictures 105r.

Interprediction involves representing the predicted picture 105p as a mathematical function of the reference picture 105r. For example, the predicted picture 100p can be represented by an equation by the weighted product of the reference picture 100r and an offset. Thus the predicted picture 100p can be encoded by encoding the weight, offset, and an identification of the reference picture. The weight and offset in the foregoing case are known as weighting parameters. This allows for a substantial data reduction.

According to certain embodiments of the present invention, the weighting statistics for pixels in the predicted picture and the reference picture can be calculated. In certain embodiments of the present invention, the statistics for each picture that can include a pixel average for each of the pixels in the picture. In another embodiment of the present invention, the statistics can include the standard deviation of pixel values in the picture.

The weight parameters for a predicted picture are calculated based on the statistics for the predicted picture and the reference picture. The predicted picture can then be encoded using the calculated weight parameters.

In certain embodiments of the present invention, the weight parameters can include a weight and an offset. The weight can be the ratio of the standard deviation of the pixels in the predicted picture to the standard deviation of the pixels in the reference picture. The offset can be the mean pixel values in the predicted picture minus the product of the weight and the mean pixel values of the reference picture.

It is noted that if the statistics for a reference picture 100r can be calculated from just the pixels in the reference picture 100r, the statistics for the reference picture 100r can be calculated once and stored. The statistics can then be retrieved for use in calculating weight parameters for a number of predicted pictures 100p.

Referring now to FIG. 2, there is illustrated a block diagram of an exemplary system 200 in accordance with an embodiment of the present invention. The system 200 comprises a memory 205 and a controller/circuit [BO, take your pick]] 210. The system 200 interpredicts pictures, e.g., pictures loop from reference pictures 100r.

The memory stores statistics for each of the pictures 100. The controller/circuit 210 calculates weight parameters for the predicted pictures based at least in part on the statistics that are stored in memory for a reference picture 100r.

In certain embodiments of the invention, the controller/circuit 210 can calculate the statistics for the pictures 100, and the statistics can be written to the memory 205. The controller/circuit 210 can comprise a variety of devices, for example, an arithmetic logic unit.

It is noted that if the statistics for a reference picture 100r can be calculated from just the pixels in the reference picture 100r, the statistics for the reference picture 100r can be calculated once and stored. The arithmetic logic unit can retrieve the statistics for use in calculating weight parameters for a number of predicted pictures 100p.

The present invention can be used in connection with a variety of video encoding standards, such as, but not limited to, VC-1 and H.264. Embodiments of the present invention will now be described in the context of an exemplary video encoding standard, H.264.

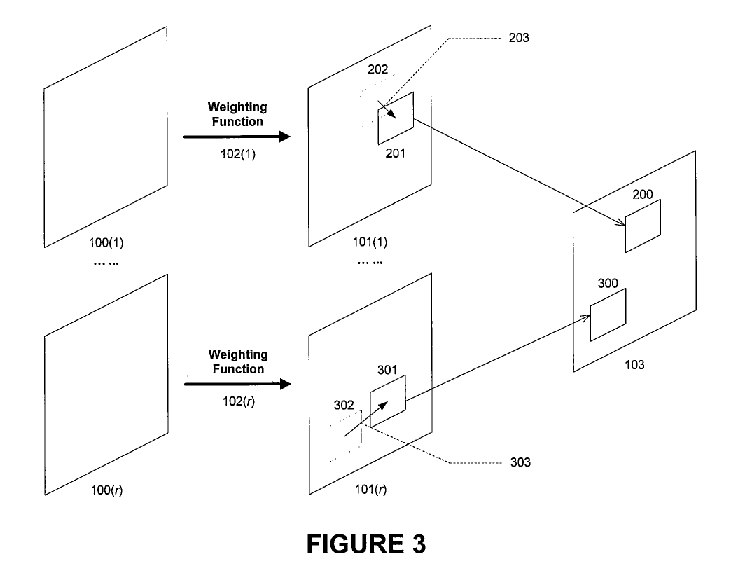

Referring now to FIG. 3, there is illustrated a block diagram describing weighted reference pictures in accordance with an embodiment of the present invention. Pictures 100(1), . . . , 100(r) are reference pictures. In an encoder, the reference pictures 100(1) . . . 100(r) are reconstructed versions of the pictures that have been previously encoded. Accordingly, the reference pictures 100(1) . . . 100(r) are available to a decoder, allowing the decoder to perform motion prediction. It is noted that the video encoder, ideally makes the reconstructed pictures as close to the original input pictures as possible. However, the use of lossy compression during video encoding may cause differences between the reconstructed pictures and the original input pictures.

The reference pictures are subjected to independent weighting functions, 102(1), . . . , 102(r), respectively. The default weighting function may be a simple pass-through function. Weight functions of various types may be used. As an example, for the AVC standard, a linear weight function is used:

P_{w}=Pᵣ*W+O,

where Pᵣ is the value of a pixel in the reference picture, P_{w} is the value of the pixel in the weighted reference picture, W is the scaling factor, and O is the offset.

The process yields weighted reference pictures, 101(1), . . . , 101(r). It is noted that there may be duplicates in the r reference pictures, 100(1), . . . , 100(r). These duplicates may be subjected to different weight functions to yield different weighted reference pictures. For example, one function may have scaling and offset, the other function may be simple pass-through.

The weighted reference pictures are used in the inter-prediction. Two blocks, 200 and 300, in a predicted picture 103 can be predicted from the weighted reference pictures 101(1), . . . , 101(r). For example, block 200 in the predicted picture 103 is predicted from block 201 in the weighted reference picture 101(1). The block 202 is the co-located block of the block 200 and represents where the block 200 should be if there is no motion. The relative disposition from the block 202 to the block 201 indicated by a motion vector 203.

The prediction of the block 300 is carried out independent from all other blocks. In the example, the block 300 in the current picture 103 is predicted from the block 301 in the weighted reference picture 101(r). It uses motion vector 303.

In order to take advantage of the weighted prediction, a video encoder calculates the weighting parameters (i.e. weight and offset) for the predicted pictures 100. This process is called a prediction weights estimation.

The prediction picture 100p can then be encoded as the weighting parameters, W and O, and with an identification of the reference picture 100r. The foregoing results in substantial compression.

It is noted that reference pictures 100r for certain prediction pictures 100p may be predicted from other reference pictures 100r. In such cases, the picture is referred to as a reference picture with respect to the predicted picture and a predicted picture with respect to the other reference picture.

One embodiment of the present invention involves statistics collection, weights estimation, and weights validation. The statistics used for prediction weights estimation can be collected for each picture as part of pre-encoding process. The statistics can be saved for future use. Since it is done once for each picture, it is more efficient than calculations based on reference-current picture pairs.

Based on the saved statistics of the reference picture and the current picture, a 2-parameter linear model can be established trying to match the statistics. These 2 parameters are used as the weights for the reference picture.

In the case of significant picture composition change, the estimated weights based on the statistics may be misleading. Accordingly, in certain embodiments, a correlation coefficient between the histograms of the weighted reference picture and the current picture are used.

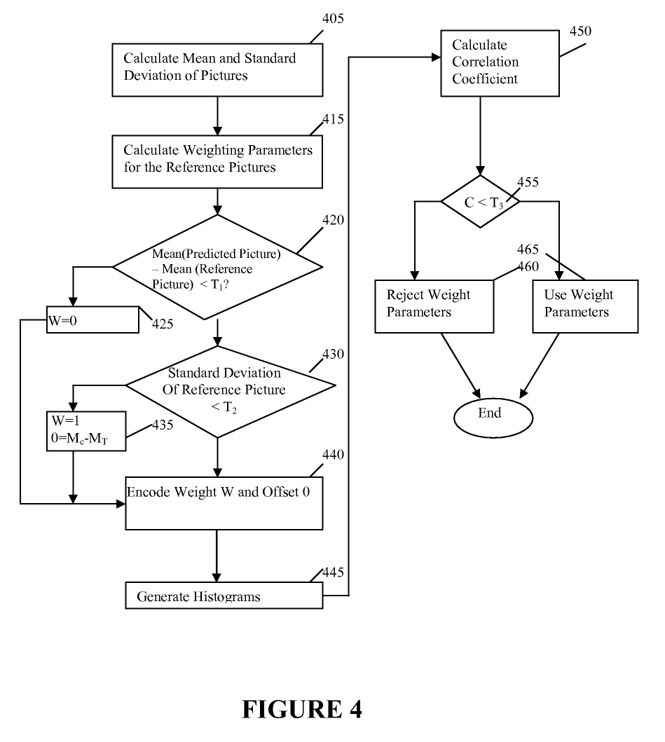

Referring now to FIG. 4, there is illustrated a flow diagram for interpredicting a picture from a reference picture in accordance with an embodiment of the present invention. The flow chart will be described in connection with FIG. 3.

At 405, the mean and standard deviation, of all the pictures including at least one predicted picture and the reference pictures are calculated. A fast algorithm based on pixel value histogram (256 bins) can be used in the calculation of the means and standard deviations.

[symbol]

where
n is the number of pixels in a picture,
P is the pixel value in the reference picture,
M is the mean pixel values in the reference picture,
D is the standard deviation of the pixel values in the reference picture

In addition, histograms of the pixel values may be collected. For a picture with bit-depth of 8, since the allowed pixel values are from 0 to 255, 256 bins may be used in the histograms:

H[0], . . . , H[255] are histograms of pixel values in the picture

At 415, for each reference picture the weighting parameters (e.g., weight and offset) are decided using the following formula:

W=D_{c}/Dᵣ

O=M_{c}−Mᵣ*W

where W is weight
and O is offset used for the reference picture.

If at 420, the difference between the mean of the pixel values in the reference picture Mᵣ and in the current picture M_{c} is less than a given threshold Mₜ, no weighting is applied to the reference picture at 425. Instead, a pass through function is used. If the difference between the current picture and the reference picture exceeds the threshold, 425 is bypassed.

If at 430, the standard deviation of the reference picture Dᵣ is smaller than another threshold Dₜ, the pixels value in the reference picture are very close to each other and clustered. In this case, a simple offset is used at 435. If the standard deviation exceeds the threshold at 430, 435 is bypassed. At 440, the weight W and offset 0 are encoded in the bitstream subjected to rounding and clipping as specified in the standard.

At 445, based on a histogram of the pixel values in the reference picture Hᵣ[0], . . . , Hᵣ[255] and previously calculated weighting parameters W and O, histograms of the pixel values of the weighted reference picture:

H_{w}[0], . . . , H_{w}[255]

are generated.

At 450, a correlation coefficient is calculated between the histograms of the pixel values in the weighted reference picture and the predicted picture as

$$C = \frac{255 * {\sum }_{i = 0}^{255} {H}_{w} [ i ] {H}_{c} [ i ] - {\sum }_{i = 0}^{255} {H}_{w} [ i ] {\sum }_{i = 0}^{255} {H}_{c} [ i ]}{\begin{matrix}\sqrt{255 * {\sum }_{i = 0}^{255} {{H}_{w} [ i ]}^{2} - {( {\sum }_{i = 0}^{255} {H}_{w} [ i ] )}^{2}} \\ \sqrt{255 * {\sum }_{i = 0}^{255} {{H}_{c} [ i ]}^{2} - {( {\sum }_{i = 0}^{255} {H}_{c} [ i ] )}^{2}}\end{matrix}}$$

The numerator represents the covariance between H_{w} and H_{c}, the denominator represents the product of standard deviations of H_{w} and H_{c}.

At 455, C is compared to a threshold. If at 455, the correlation coefficient C is below the threshold, the estimated weighting parameters are rejected at 460 and no weighting is performed on the reference picture. If at 455, the correlation coefficient C is above the threshold, the estimated weighting parameters are used at 465.

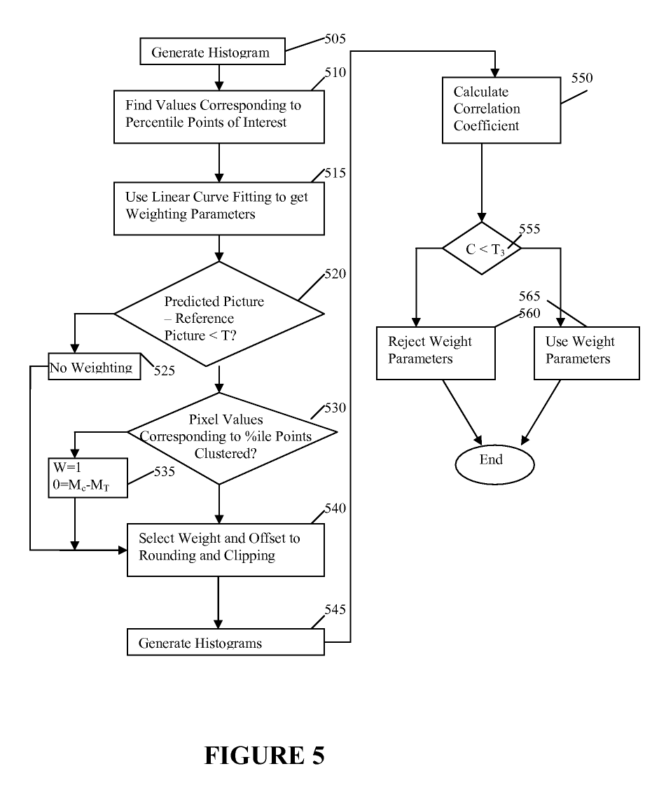

Referring now to FIG. 5, there is illustrated a flow diagram for interpredicting in accordance with another embodiment of the present invention. At 505, histograms of pixels values in the reference picture and the predicted picture are generated:

Hᵣ[0], . . . , Hᵣ[255] are the histograms of pixel values in the reference picture,
H_{c}[0], . . . , H_{c}[255] are the histograms of pixel values in the current picture.

At 510, pixel values corresponding to the percentile points of interest in both the reference picture and the predicted picture are found:

$${P}_{r} [ i ] = p + ( C [ i ] - {\sum }_{q = 0}^{p - 1} {H}_{r} [ q ] ) / {H}_{r} [ p ] , if {\sum }_{q = 0}^{p - 1} {H}_{r} [ q ] \leq C [ i ] < {\sum }_{q = 0}^{p} {H}_{r} [ q ]$$

$${P}_{c} [ i ] = p + ( C [ i ] - {\sum }_{q = 0}^{p - 1} {H}_{c} [ q ] ) / {H}_{c} [ p ] , if {\sum }_{q = 0}^{p - 1} {H}_{c} [ q ] \leq C [ i ] < {\sum }_{q = 0}^{p} {H}_{c} [ q ]$$

where m is the number of percentile points of interest,
I[i], i=1, . . . , m are the percentile points of interest (0≦I[i]≦1 for i=1, . . . , m),
C[i], i=1, . . . , mare the pixel counts corresponding to the percentile points (C[i]=n*I[i] for i=1, . . . , m),
Pᵣ[i], i=1, . . . , m are the pixel values corresponding to the percentile points of interest in the reference picture,
P_{c}[i], i=1, . . . , m are the pixel values corresponding to the percentile points of interest in the current picture.

Note that in a picture, there may be many pixels at each integer pixel value. Strictly speaking, the percentile point falls between two adjacent integer pixel values. However, fractional pixel values can be used as given in the formula above.

Last, given the m pairs of Pᵣ[i] and P_{c}[i], at 515, linear curve fitting is used to get the weighting parameters for the best linear model:

$$W = \frac{{\sum }_{i = 0}^{m} {P}_{r} [ i ] {\sum }_{i = 0}^{m} {P}_{c} [ i ] - m {\sum }_{i = 0}^{m} {P}_{r} [ i ] {P}_{c} [ i ]}{{( {\sum }_{i = 0}^{m} {P}_{r} [ i ] )}^{2} - m {\sum }_{i = 0}^{m} {{P}_{r} [ i ]}^{2}}$$

$$O = \frac{1}{m} ( {\sum }_{i = 0}^{m} {P}_{c} [ i ] - W * {\sum }_{i = 0}^{m} {P}_{r} [ i ] )$$

where W is weight and O is offset used for the reference picture.

At 520, if the difference between the current picture and the reference picture is smaller than a threshold, no weighting is applied to the reference picture (W=1) at 525. At 530, if the pixel values corresponding to the percentile points are clustered, W=1 and O=M_{c}−Mᵣ (no scaling, just offset) are used at 535.

At 540, the weight (W) and offset (O) encoded in the bitstream are subjected to rounding and clipping as specified in the standard.

One aspect of this multi-point curve fitting method is the choice of the percentile points of interest.

Here are some considerations:

(1) A large range of the percentile points (e.g. from 0 to 1) would yield a linear model that accommodates more pixels;

(2) The choice of percentile points can also be made to exclude complete black regions, such as the black stripes in letterbox sequences (e.g. do not include percentile point in the lower 25%);

(3) The choice of percentile points can also be perceptual related, in which case more percentile points are located in the intensity range that is perceptually more important.

At 545, based on a histogram of the pixel values in the reference picture Hᵣ[0], . . . , Hᵣ[255] and previously calculated weighting parameters W and O, histograms of the pixel values of the weighted reference picture:

H_{w}[0], . . . , H_{w}[255]

are generated.

At 550, a correlation coefficient is calculated between the histograms of the pixel values in the weighted reference picture and the predicted picture as

$$C = \frac{255 * {\sum }_{i = 0}^{255} {H}_{w} [ i ] {H}_{c} [ i ] - {\sum }_{i = 0}^{255} {H}_{w} [ i ] {\sum }_{i = 0}^{255} {H}_{c} [ i ]}{\begin{matrix}\sqrt{255 * {\sum }_{i = 0}^{255} {{H}_{w} [ i ]}^{2} - {( {\sum }_{i = 0}^{255} {H}_{w} [ i ] )}^{2}} \\ \sqrt{255 * {\sum }_{i = 0}^{255} {{H}_{c} [ i ]}^{2} - {( {\sum }_{i = 0}^{255} {H}_{c} [ i ] )}^{2}}\end{matrix}}$$

The numerator represents the covariance between H_{w} and H_{c}, the denominator represents the product of standard deviations of H_{w} and H_{c}.

At 555, C is compared to a threshold. If at 555, the correlation coefficient C is below the threshold, the estimated weighting parameters are rejected at 560 and no weighting is performed on the reference picture. If at 555, the correlation coefficient C is above the threshold, the estimated weighting parameters are used at 565.

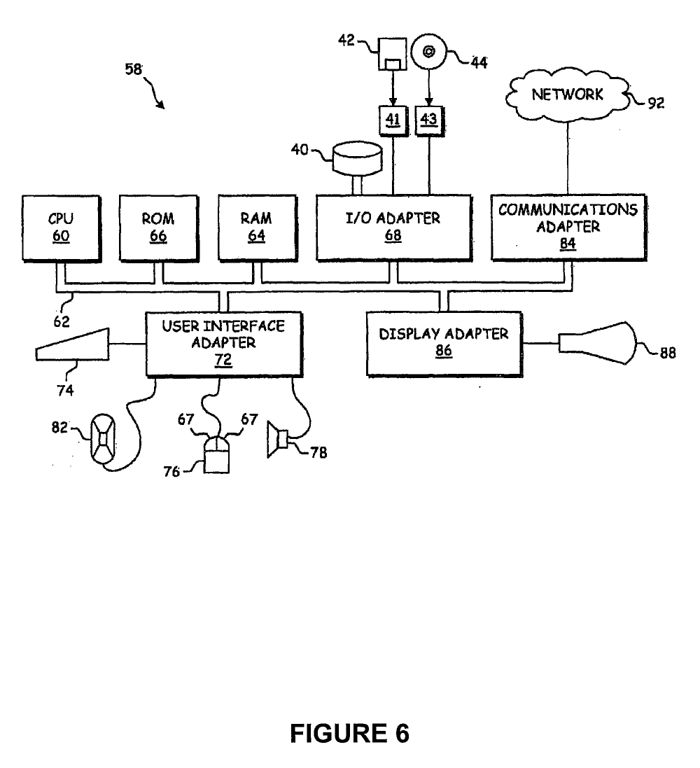

Referring now to FIG. 6, a representative hardware environment for a computer system 58 for practicing the present invention is depicted. It should be understood that the computer system 58 may be a desktop computer system, a set-top box system such as used in connection with satellite or cable television, a mobile computer system such as a laptop, or a handset system such as a PDA, smart phone or cellular phone, for example. A CPU 60 is interconnected via system bus 62 to random access memory (RAM) 64, read only memory (ROM) 66, an input/output (I/O) adapter 68, a user interface adapter 72, a communications adapter 84, and a display adapter 86. The input/output (I/O) adapter 68 connects peripheral devices such as hard disc drives 40, floppy disc drives 41 for reading removable floppy discs 42, and optical disc drives 43 for reading removable optical disc 44 (such as a compact disc or a digital versatile disc) to the bus 62. The user interface adapter 72 connects devices such as a keyboard 74, a mouse 76 having a plurality of buttons 67, a speaker 78, a microphone 82, and/or other user interfaces devices such as a touch screen device (not shown) to the bus 62. The communications adapter 84 connects the computer system to a network 92. The display adapter 86 connects a monitor 88 to the bus 62.

The communications adapter 84 connects the computer system 58 to other computers systems 58 over network 92. The computer network 92 can comprise, for example, a local area network (LAN), a cable or satellite network, a wide area network (WAN), a cellular network or the internet. Additionally, a particular one of the computer systems 58 can act as a server. A computer server 58a centralizes files and functions and provides access to the files and functions to the other computer systems 58 within the network 92. Moreover, in some embodiments, the CPU 60 can be a baseband or other control processor having separate or integrated encoding and decoding functionality.

An embodiment of the present invention can be implemented as sets of instructions resident in the random access memory 64 of one or more computer systems 58 configured generally as described in FIG. 6. Until required by the computer system 58, the set of instructions may be stored in another computer readable memory, for example in a hard disc drive 40, or in removable memory such as an optical disc 44 for eventual use in an optical disc drive 43, or a floppy disc 42 for eventual use in a floppy disc drive 41. Those skilled in the art will recognize that the physical storage of the sets of instructions physically changes the medium upon which it is stored, electrically, magnetically, chemically, or mechanically, so that the medium carries computer readable information.

The present invention is directed to systems and methods for prediction weight estimation shown in and/or described in connection with at least one of the figures, as set forth more completely in the claims.

These and other features and advantages of the present invention may be appreciated from a review of the following detailed description of the present invention, along with the accompanying figures in which like reference numerals refer to like parts throughout.

1. A method for interpredicting a picture from at least one reference picture, said method comprising:
calculating statistics for pixels in the picture and the reference picture;
generating weight parameters for the picture based on the statistics; and
encoding the picture using said weight parameters.

2. The method of claim 1, further comprising:
calculating statistics for another picture; and
generating weight parameters for the another picture based on the statistics for the another picture and the reference picture.

3. The method of claim 1, wherein the statistics comprise an average pixel value.

4. The method of claim 1, wherein the statistics comprise standard deviation.

5. The method of claim 1, further comprising:
encoding the picture using said weight parameters based on pixel value distibution density.

6. The method of claim 1, wherein the weight parameters comprise an offset.

7. The method of claim 1, further comprising:
calculating statistics for pixels in another picture; and
generating weight parameters for the another picture based at least in part on statistics for the another picture and the stored statistics for the at least one reference picture.

8. An article of manufacture comprising computer readable media, said computer readable media further comprising a plurality of instructions, wherein execution of the instructions causes:
calculating statistics for pixels in a picture and a reference picture;
generating weight parameters for the picture based on the statistics; and
encoding the picture using said weight parameters.

9. The article of manufacture of claim 8, wherein the plurality of instruction further causes:
calculating statistics for another picture; and
generating weight parameters for the another picture based on the statistics for the another picture and the reference picture.

10. The article of manufacture of claim 8, wherein the statistics comprise an average pixel value.

11. The article of manufacture of claim 8, wherein the statistics comprise standard deviation.

12. The article of manufacture of claim 8, wherein the plurality of instruction further causes:
encoding the picture using said weight parameters based on pixel value distibution density.

13. The article of manufacture of claim 8, wherein the weight parameters comprise an offset.

14. A circuit for interpredicting pictures, said circuit comprising:
a memory for storing statistics for each of a plurality of pictures; and
an controller/circuit for calculating weight parameters for at least one of the plurality of pictures based at least in part on the stored statistics for another one of the plurality of pictures.

15. The circuit of claim 14, wherein the controller/circuit calculates weight parameters for one other picture based at least in part one the stored statistics for the another one of the plurality of pictures.

16. The circuit of claim 14, wherein the statistics for each of the plurality of pictures can be calculated from the pixels of each picture.

17. The circuit of claim 14, wherein the controller/circuit calculates the statistics for each of the plurality of pictures.
